(19) United States
(12) Patent Application Publication
(10) Pub. No.: US 2004/0039940 A1
(43) Pub. Date: Feb. 26, 2004

(54) Hardware-based packet filtering accelerator

(75) Inventors: George Cox, Richmond, VA (US); Jeff Courington, Chester, VA (US)

Correspondence Address: Corporate Patent Counsel, Philips Electronics North America Corporation, 580 White Plains Road, Tarrytown, NY, 10591, US

(73) Assignee: Koninklijke Philips Electronics N.V.

(21) Appl. No.: 10/227,368

(22) Filed: Aug. 23, 2002

(51) Int. Cl. H04L 9/00

(52) U.S. Cl. 713/201

(57) ABSTRACT

A data packet filtering accelerator processor operates in parallel with a host processor and is arranged on an integrated circuit with the host processor. The accelerator processor classifies data packets by executing a sequence machine code instructions converted directly from a set of rules. Portions of data packets are passed to the accelerator processor from the host processor. The accelerator processor includes packet parser circuit for parsing the data packets into relevant data units and storing the relevant data units in memory. A packet analysis circuit executes the sequence of machine code instructions converted directly from the set of rules. The machine code instruction sequence operates on the relevant data units to classify the data packet. The packet analysis circuit returns the results of the classification to the host processor by storing the classification results in a register accessible by the host processor.

### RELATED PATENT DOCUMENT

This application is related to co-pending patent application entitled “EMBEDDED DATA SET PROCESSING,” U.S. patent application Ser. No. ______ (Docket No. 703128), concurrently-filed herewith and incorporated herein by reference in its entirety.

### FIELD OF THE INVENTION

The present invention relates generally to data processing and, more particularly, to a hardware accelerator for filtering data packets.

### BACKGROUND OF THE INVENTION

The internet provides access to a variety of internet-based services and information sources. For many users, access to the internet at work and at home is an essential tool. However, connecting a private network or workstation to the internet presents several obstacles. For example, unless adequately protected, a connection to the internet can expose a user's confidential information to unscrupulous intruders located worldwide. Internet security has been implemented using firewalls to protect both individual computers and corporate networks from hostile attack through the internet connection. A typical firewall operates by filtering incoming and outgoing data packets at the private network interface to reject potentially harmful communications.

Information is typically transmitted over the internet in one or more data sets or data packets defined in accordance with a data communication protocol. Transmission Control Protocol/Internet Protocol (TCP/IP) is an example of a suite of communication protocols used for internet applications. TCP is the protocol used to establish a connection between two networked computers so that streams of data may be exchanged. TCP also establishes a method for ensuring delivery of the data and ensuring that information packets are delivered in the correct order. Internet protocol (IP) specifies the format of data packets, also called datagrams, transferred between internet-connected computers. IP also specifies the addressing scheme used to transfer a data packet from one computer to another.

An effective type of firewall uses packet filtering to secure a private network or computer. Firewalls may be implemented as hardware devices, or may be implemented as a software application. In either case, the firewall is situated between the connecting networks. For example, the firewall may be implemented in an interface device located between a private network and the internet to protect the private network from intrusion through the internet connection.

A packet-filtering firewall uses a packet filter to inspect each IP packet or datagram entering or leaving the network. A packet is accepted or rejected based on a set of user-defined rules. A packet filter intercepts each data packet and compares each packet to the set of rules before the packet is forwarded to its destination. The comparison may be implemented as a table lookup application comparing various IP packet header fields to values in a look-up table. A packet header field is compared to values in the look up table until either a matching entry in the table is found, or until no match is found and a default rule is selected. Typically, the comparison performed by the packet filter involves the source address, the source port, the destination address, and the destination port, and transport protocol.

Filtering on source and destination addresses grants control over who may communicate with the internal network. All traffic from undesirable networks can be screened out by the packet filter. Source and destination ports, on the other hand, are used to distinguish network services. By filtering out a port, it is possible to deny the outside world access to a service offered on the private network. Based on the comparison of the packet to the criteria, a packet may be dropped, forwarded to the destination, or dropped with a message to the packet source.

Although firewalls utilizing packet filtering techniques provide a level of security to private computer networks, they also create a traffic bottleneck by forcing all data traffic into and out of a private network through the firewall. There is a need in the industry for faster and more efficient methods to implement packet filtering.

### SUMMARY OF THE INVENTION

The present invention is directed to a method and system that provides accelerated data communications for networked systems and has been found to be particularly useful for providing high speed data packet filtering.

According to an embodiment of the present invention, an accelerator processor classifies data packets according to a set of rules and returns the results of the classification to the host processor. The accelerator processor operates in parallel with a host processor and communicates with the host processor over a parallel bus. The host processor and the accelerator processor are arranged as an integrated circuit. The accelerator processor includes a bus interface coupled to the parallel bus and adapted to transfer a portion of the data packet from the host processor and return the results of the classification of the data packet to the host processor. The accelerator processor further includes a memory coupled to the bus interface and accessible to the host processor. The memory is adapted to store a program of machine code instructions converted from the ruleset to be applied to the data packets. The memory also stores the results of the classification determined by the accelerator processor. The accelerator processor further includes packet parser circuitry coupled to the bus interface and adapted to parse data packet portions transferred from the host processor into relevant data units and to store the relevant data units in the memory within the accelerator processor. Packet analysis circuitry of the accelerator processor is coupled to the memory unit and is arranged to execute the program of machine code instructions representing the set of rules to be applied to the data packets. The machine code instructions operate on the relevant data units parsed from the data packet portions to classify the packets.

In another embodiment of the invention, a method for classifying data packets according to a set of rules includes storing a program of machine instructions converted directly from the set of rules in the memory of an accelerator processor. Portions of a data packet are transferred from a host processor to the accelerator processor. The data packet portions are parsed into relevant data units and the relevant data units are stored in the memory of the accelerator processor. Data packets are classified by executing the machine code instructions in the accelerator processor; the machine code instructions operating on the relevant data units. The result of the classification is returned from the accelerator processor to the host processor.

A further embodiment of the invention involves a system including means for storing in a memory unit of an accelerator processor a program of machine code instructions converted directly from the set of rules, means for transferring one or more portions of the data packets from a host processor to the accelerator processor, means for parsing portions of the data packets into relevant data units and storing the relevant data units in the memory unit of the accelerator processor, means for classifying each data packet by executing the program of machine code instructions in the accelerator processor using the relevant data units, and means for returning the results of the classification from the accelerator processor to the host processor.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is a diagram of a network with an interface circuit implementing an accelerator processor for filtering data packets in accordance with an embodiment of the invention;

FIG. 2 is a block diagram of an interface circuit with a host processor and an accelerator processor in accordance with an embodiment of the invention;

FIG. 3 is an illustration of chained linear and tree rules sets in accordance with an embodiment of the invention;

FIG. 4 is a flowchart illustrating data packet filtering according to an embodiment of the invention;

FIG. 5 is a block diagram of an accelerator processor for classifying data sets in accordance with an embodiment of the invention;

FIG. 6 is an example illustration of a data set structure;

FIG. 7 is a memory map of an embedded processor for classifying data sets in accordance with an embodiment of the present invention;

FIG. 8 is an illustration of the structure of a command word in accordance with an embodiment of the invention;

FIG. 9 is an illustration of the structure of a status word in accordance with an embodiment of the invention;

FIG. 10 is a flowchart illustrating a specific example of accelerator processor code implementing a rule for passing UDP packets with a particular destination port in accordance with an embodiment of the invention;

While the invention is amenable to various modifications and alternative forms, specifics thereof have been shown by way of example in the drawings and will be described in detail below. It is to be understood, however, that the intention is not to limit the invention to the particular embodiments described. On the contrary, the invention is intended to cover all modifications, equivalents, and alternatives falling within the scope of the invention as defined by the appended claims.

### DETAILED DESCRIPTION OF VARIOUS EMBODIMENTS

In the following description of the illustrated embodiments, references are made to the accompanying drawings which form a part hereof, and in which is shown by way of illustration, various embodiments in which the invention may be practiced. It is to be understood that other embodiments may be utilized, and structural and functional changes may be made without departing from the scope of the present invention.

In one embodiment, a hardware-based accelerator, operating in parallel with a host interface processor, is adapted to parse, examine and classify data packets in accordance with a set of rules. The results of the classification are passed to the host processor for use in further processing the data packet. The parallel-connected accelerator has been found particularly useful for filtering IP packet datagrams, for example. The packet filter accelerator described herein may be advantageously used to offload packet filtering functions from a host interface processor. The present invention provides a flexible hardware accelerator for data set classification in packet filtering applications thereby enhancing high speed data processing operations of a network interface.

One aspect of the invention includes data packet parsing circuitry to parse a data packet passed to the accelerator processor by the host processor into component units. Key fields of a data packet, such as an IP datagram, may be parsed into relevant data units and stored in memory for further action.

Another aspect of the invention includes rules engine logic executing a sequence of machine code instructions converted directly from a set of rules to classify the data packet. The rules engine logic provides the results of the classification to the host processor through a register accessible by the host processor. Thus, the invention provides a flexible hardware assist enhancing high speed data packet filtering operations.

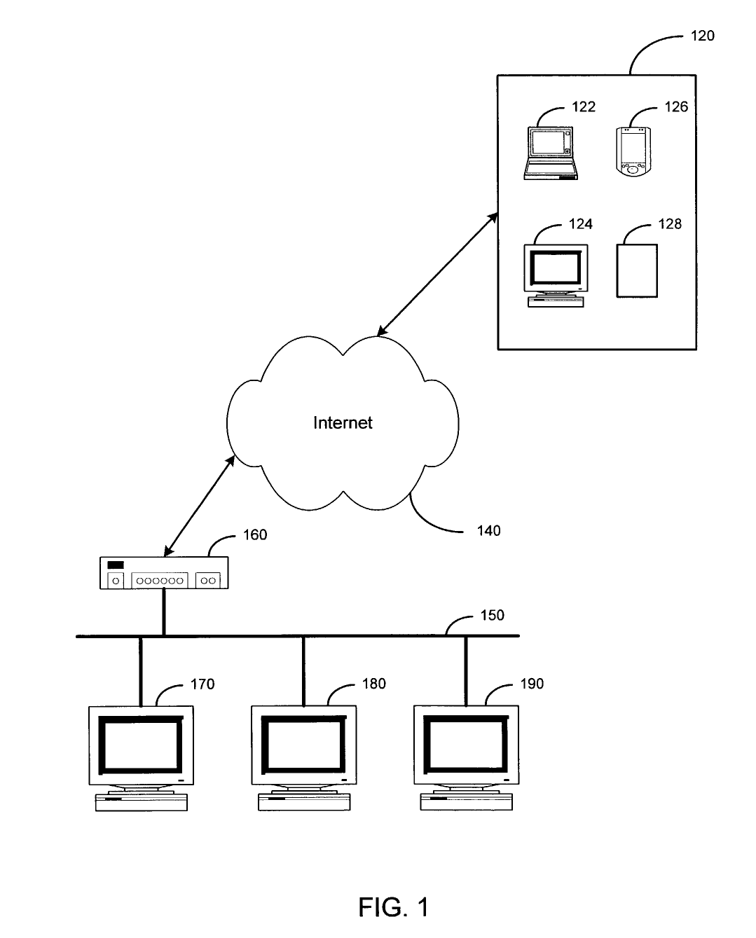

FIG. 1 provides an example of a general network architecture that may be used to accommodate data transfer between one or more data processing terminals in accordance with an embodiment of the invention. A source terminal 120 may transfer data packets, for example IP packets, over the internet 140, to one or more destination terminals 170, 180, 190. A terminal may be a laptop terminal 122, a desktop terminal, a wireless device 126, such as a personal data assistant (PDA), or any other type of data processing terminal 128. The destination terminals 170, 180, 190 may be arranged in a private network 150 accessible through an interface device 160. The interface device 160 may be a firewall implementing IP packet filtering tasks, for example, blocking undesirable or potentially unsafe data packets.

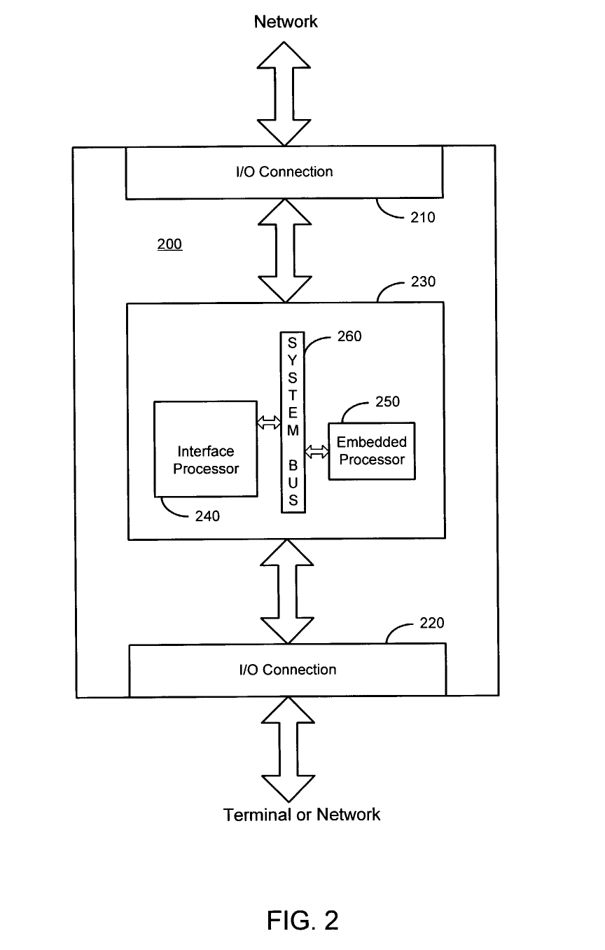

A block diagram of a network interface 200 in accordance with one example embodiment of the invention is illustrated in more detail in FIG. 2. The interface 200 may be used to connect a private terminal or network to the internet through appropriate input/output connections 210, 220. The majority of the interface circuitry 230 may be incorporated in one or more integrated circuits coupled between the I/O connections 210, 220. In accordance with one embodiment of the invention, the interface circuitry 230 includes a host processor 240 and an accelerator processor 250 coupled through a system bus 260. For example, the host processor 240 and the embedded processor may be arranged on an integrated circuit with the host processor 240 implemented using a processor core, such as an ARM or MIPS processor core, and coupled to the accelerator processor 250 through a high speed parallel bus structure.

The host processor 240 and the accelerator processor 250 are arranged to operate in parallel. In this configuration, the host processor 240 performs the bulk of data processing tasks. The accelerator 250 offloads the tasks of IP packet parsing and classification from the host processor 240, thereby freeing the host processor 240 from a portion of the time-consuming processing overhead associated with packet filtering operations.

The host processor 240 controls the operation of the accelerator processor 250 and manages the set of rules applied by the accelerator processor 250 for packet filtering. For example, the host processor 240 may initiate and terminate the use of an accelerator processor 250, copy the accelerator processor registers to the host processor 240, or overwrite the contents of the accelerator processor registers with alternate values.

In the exemplary configuration discussed herein, the host processor 240 converts a set of rules to be applied to the data packets into machine code executable by the accelerator processor 250. The host processor 240 downloads the rules machine code to an instruction cache located within the accelerator processor 250. The rules may be modified or updated as required. The rules machine code may be based upon the current data set, or based upon the expected reply to the current data set, for example, to open return holes in a firewall.

Linear rulesets and tree rulesets may be converted into machine code and applied by the accelerator processor 250. Other ruleset types may also be applied. A ruleset may range from 0 to many rules. A rule is typically implemented, for example, in about 5-10 machine code instructions. A linear ruleset is suited for analyzing a data set against a defined set of rules where the order of the rules is critical. When the accelerator processor 250 analyzes a data packet against a linear ruleset, the data packet is compared to the rules linearly through the list of rules, starting with the first rule and continuing through the rules until either a rule matches the data set or comparison of the data set to the rule set is complete. One example of a linear ruleset is testing an IP datagram against a statically defined set of packet filter rules.

A tree ruleset does not have a predetermined sequential flow, but provides a number of branching options depending, for example, on a result of the previous operation. A tree ruleset is suited for analyzing a data set against a large table of rules where the order of rule examination is not important. An example of a tree rule set is a network address translation table where the applicable rule is determined by quickly searching the tree using an IP address, IP port, and protocol as key values.

A ruleset may have additional rulesets chained from a particular rule set. The chained rulesets may be linear or tree rulesets. In some applications, a ruleset may consist of a preamble of several linear rules, followed by a large tree ruleset.

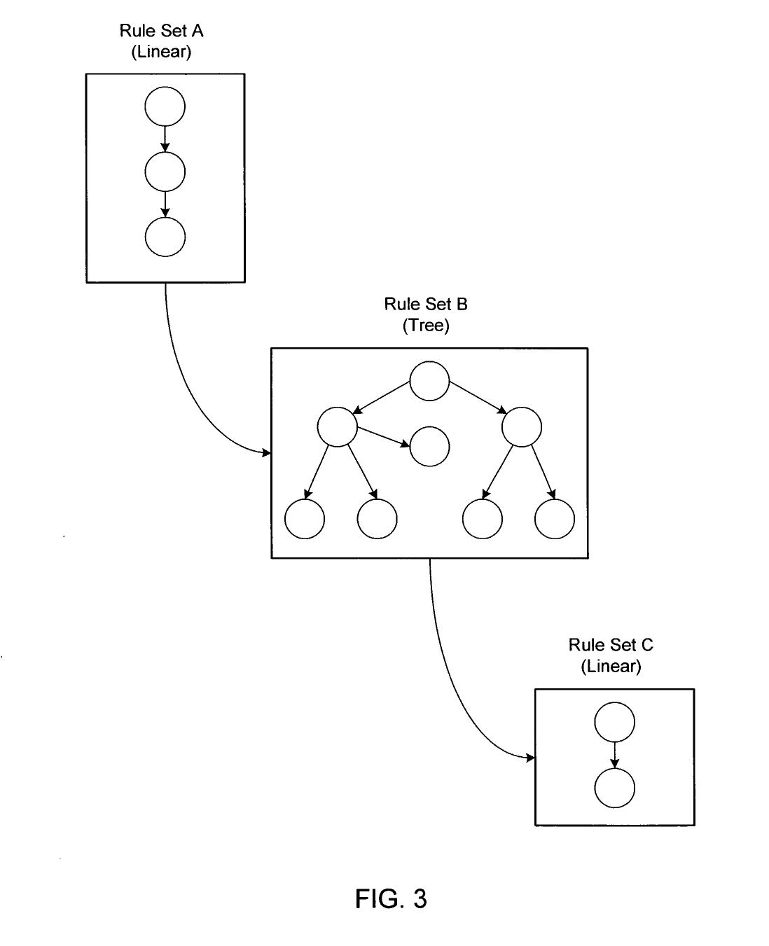

FIG. 3 is an example illustrating analysis of a data packet using both linear and tree rule sets. A data packet is first analyzed in relation to Rule Set A. If the data packet is analyzed against Rule Set A and does not match any rules in Rule Set A, then the data packet is analyzed against Rule Set B. If no matching rule is found in Rule Set B, then the data packet is analyzed against Rule Set C. Rule Set C ends in an absolute rule that matches all data packets and the classification is complete. The accelerator processor returns the result of the classification to the host processor.

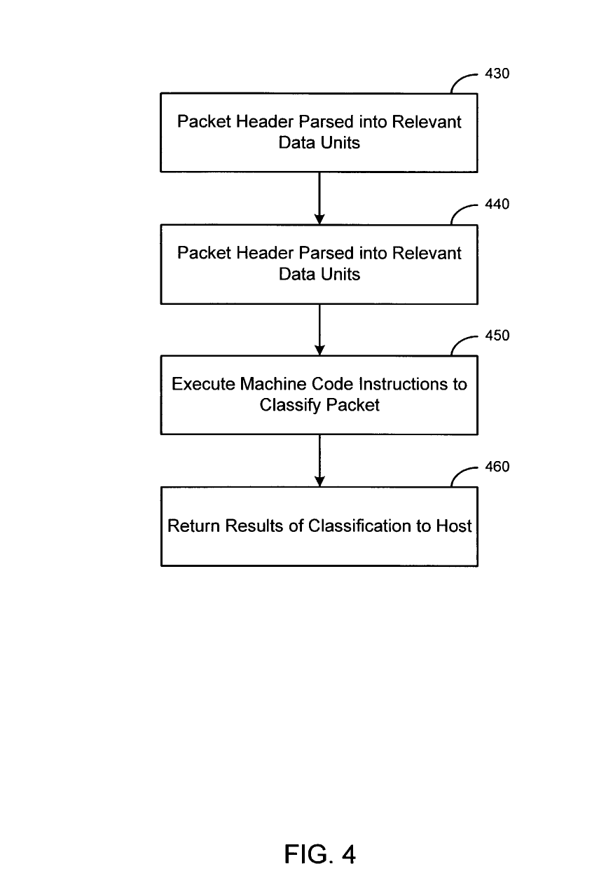

The flowchart of FIG. 4 illustrates an IP packet filtering process in accordance with an embodiment of the invention. The set of rules to be applied to the data packets is converted into a sequence of machine code instructions executable by the accelerator processor. The sequence of machine code instructions is downloaded to the accelerator processor and stored in the instruction cache of the accelerator processor. When an IP packet arrives at the host processor, the header of the IP packet is passed to the accelerator device by host processor for use in classifying the IP packet. The packet header is parsed 430 into relevant data units by the parsing circuitry of the accelerator processor. Relevant data units parsed from the packet header are stored 440 in the memory of the accelerator processor. The accelerator processor executes the machine code instructions operating on the relevant data units to classify the packet 450. The result of classifying the packet is reported 460 to the host processor. The host processor may then process the data packet in accordance with the classification determined by the accelerator processor.

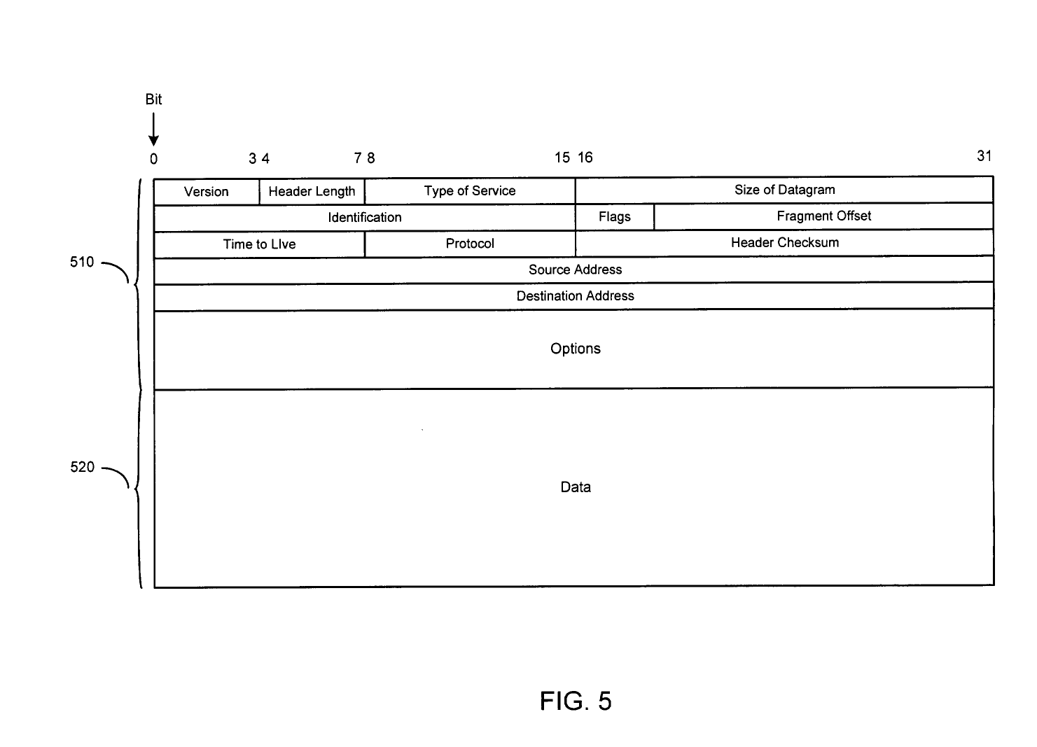

The structure of an IP datagram is illustrated in FIG. 5. The IP packet illustrated may be considered to have two main sections, a packet header section 510 and a data section 520. The entire packet, including the header 510 and data 520 portions, is denoted a datagram. The packet header 510 is typically twenty bytes in length. Although an IP packet header includes an options section, this section may be unused. An explanation of the IP packet header fields is provided below in Table 1.

TABLE 1

| | |
|---|---|
| Version | The current version of internet protocol (IP) |
| Header Length | Specifies number of 32-bit words forming the |
| | header (usually five) |
| Type of Service | Indicates the particular quality of service needs from |
| | the network |
| Size of Datagram | The combined length of the header and data |
| Identification | A 16-bit number that, together with the source |
| | address uniquely identifies the packet. The ID is |
| | used during reassembly of fragmented datagrams |
| Flags | Used to control whether routers are allowed to |
| | fragment a packet and to indicator the parts of a |
| | packet to the receiver |
| Fragment Offset | A byte count from the start of the original sent |
| | packet set by any router that performs fragmentation |
| Time to Live | Number of links that the packet may be routed over, |
| | decremented by most routers and used to prevent |
| | accidental routing loops |
| Protocol | Indicates the type of packet being carried (e.g. |
| | ICMP, TCP, UDP, etc. |
| Header Checksum | 2's compliment checksum inserted by the sender and |
| | updated when modified by a router. |
| Source Address | The IP address of the original sender of the packet |
| Destination Address | The IP address of the final destination of the packet |
| Options | This field is not normally used |

Various transport protocols, such as TCP and UDP, may be used in conjunction with the IP packet to establish a connection between two networked computers so that streams of data may be exchanged. A TCP or UDP header typically follows the IP header, supplying information specific to the TCP or UDP protocols, respectively. Transport protocol headers, e.g., TCP and UDP headers, include additional information that may also be used by the accelerator processor to classify the data packet.

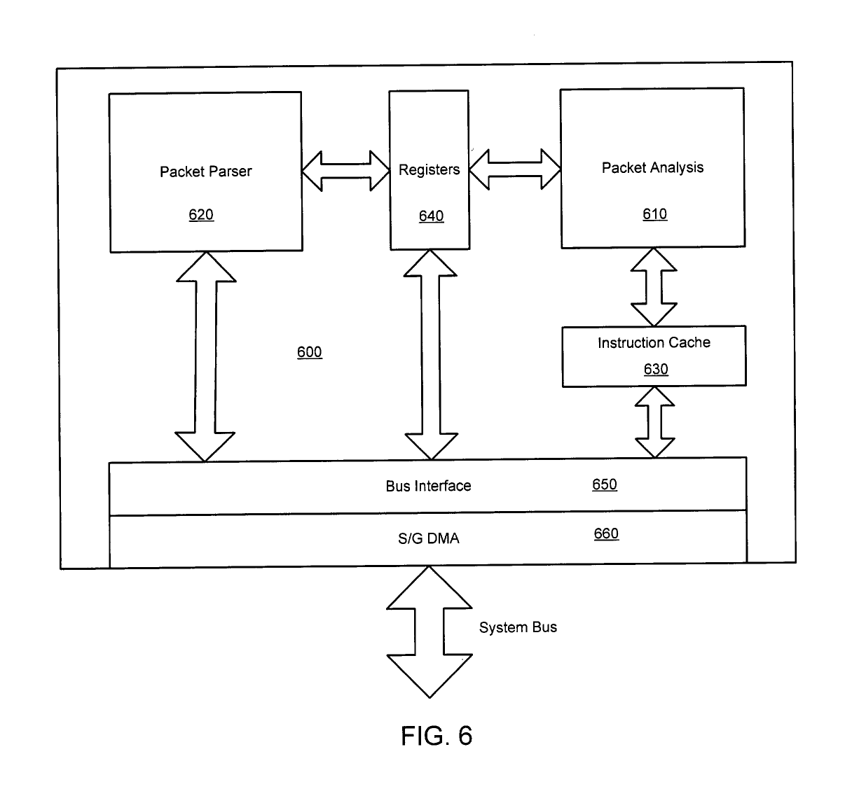

The structure of the accelerator processor is illustrated in the block diagram of FIG. 6. The accelerator processor 600 provides packet analysis rules engine logic 610, implemented as a very reduced instruction set computer (vRISC), linked with hardware-based data set parser logic 620. A program of machine code instructions representing the set of rules used to classify the data set is stored in an instruction cache 630 located within the embedded processor memory. The data set parser logic 620 parses the packet header and places relevant data units of the packet header into one or more registers 640. For example, the relevant data units stored in the registers may be the source and destination addresses from the IP datagram header and the destination port and source port values from the TCP header. The vRISC rules engine logic 610 executes a program of machine code instructions to classify the data packet based on the parsed relevant data units parsed from the packet header and stored in the registers 640.

The host processor has access to the data set parser logic 620, registers 640, and instruction cache 630 through a bus interface 650. The bus interface may be coupled through direct memory access (DMA) 660 such as a scatter/gather DMA to feed data set information from the host processor (not shown) to the data set parser logic 620.

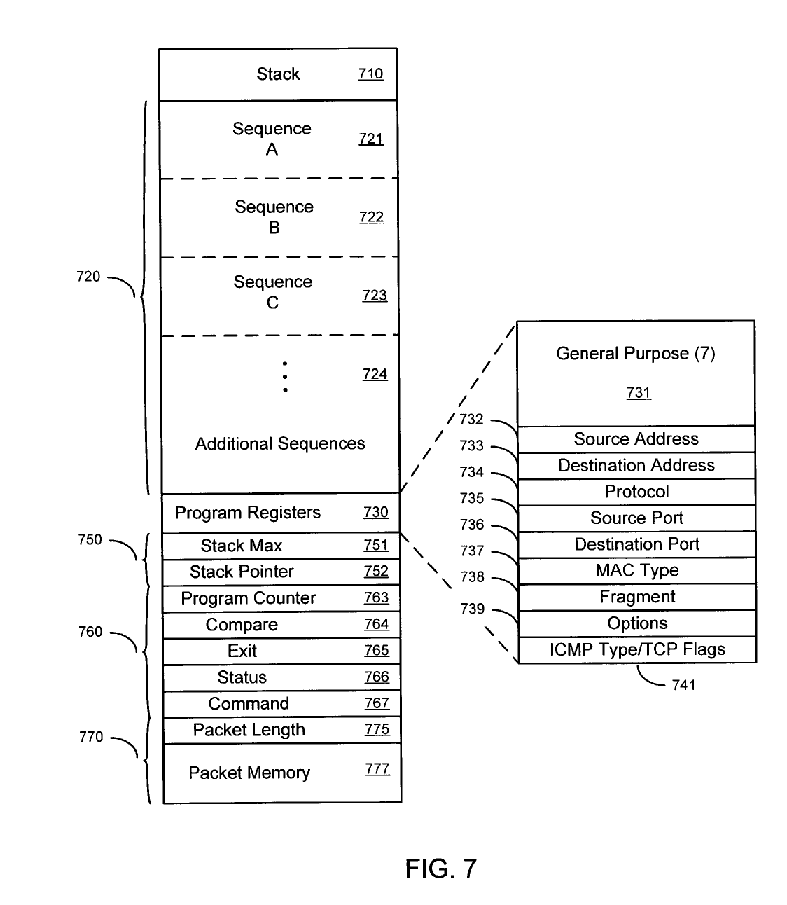

An illustration of a memory map of the accelerator processor memory is provided in FIG. 7. Embedded processor memory may be broadly divided into a stack 710, program memory 720, sixteen program registers 730, two stack control registers 750, four program control registers 760 and two memory control registers 770.

The accelerator processor stack 710 may be implemented as a push-down stack located at the top of memory. Stack control is implemented by the stack control registers 750. The size of the stack is determined by a StackMax register 751 in the accelerator processor memory. Each value pushed onto the stack is represented as a 32-bit unsigned value. If the value being pushed is a 16-bit value, then the most significant 16-bits of the pushed stack entry are represented as zeros. Initially, the stack pointer register 752 contains a value of zero, and as each value is pushed onto the stack, the stack pointer register 752 is incremented by four bytes. If the stack pointer register 752 increments past the value in the StackMax register 751, or decrements below zero, program execution is halted, the error is recorded in a status register 756, and an interrupt is delivered to the host interface processor.

The machine code instruction sequences representing the rules to be applied to data packets by the rules engine vRISC are organized in one or more instruction sequences 721, 722, 723 located in the program section 720 of the accelerator processor memory. A rule may consist of a group of comparison operations and other related operations performed using the relevant data units parsed from the data packet header and stored in the registers of the accelerator processor. The host processor indicates to the accelerator processor where the machine instruction sequence execution should start by writing to a command register 767. The starting point of instruction sequence execution is dependent on the particular set of rules being applied to the data packet. For example, analysis of a first data packet according to one rule set may require the execution of machine code instruction sequence to proceed from the beginning of instruction sequence A 721. To analyze a second data packet, or to further analyze the first data packet, the execution of instructions may start at a different location in memory associated with the beginning of instruction sequence B 722.

In an example embodiment, the accelerator processor uses sixteen 32-bit registers 730 for various operations in connection with data set analysis. Seven registers are general purpose and may be accessed by the accelerator processor or the host processor. Nine special purpose registers, described in Table 2, are used by the data set parsing logic to store relevant data units.

TABLE 2

| Register | Description |
|---|---|
| Source Address | Stores the source address of the IP packet. |
| Destination Address | Stores the destination address of the IP packet. |
| Protocol | Stores the code for the IP protocol used by the |
| | packet. The protocol field only consumes the first |
| | 8 bits of the register. |
| Source Port | Stores the source port for the packet if the packet |
| | is a user datagram protocol (UDP) or transport |
| | control protocol (TCP) packet. The source port |
| | value consumes the first 16 bits of the register. If |
| | the packet is not TCP or UDP, then the value of |
| | this register is undefined. |
| Destination Port | Stores the destination port for the packet if the |
| | packet is a UDP or TCP packet. The destination |
| | port value consumes the first 16 bits of the |
| | register. If the packet is not TCP or UDP, then the |
| | value of the register is undefined. |
| MAC type | Stores the media access control (MAC) type field |
| | from an Ethernet frame. |
| Fragment | Stores the fragment number and the more |
| | fragments bit from the current IP Packet. This |
| | register will be nonzero if the packet is part of a |
| | fragment. |
| Options | Stores a bit vector indicating the option types |
| | present in the packet. |
| ICMP type/TCP flags | Stores the value of the internet control message |
| | protocol (ICMP) type field if the packet is an |
| | ICMP packet. Stores the value of the TCP flags |
| | field if the packet is a TCP packet. |

Memory control registers 770 are used to control the transfer of portions of a data packet, such as the packet header, to the accelerator processor memory. The data set length register 775 specifies the number of bytes that will be written to the accelerator processor memory. The packet memory register 776 provides the location to which the host processor, or the DMA controller, may write to the accelerator processor memory.

Program control registers 760 include the program counter 763, compare register 764, exit register 765, status register 766, and command register 767. The program counter 763 is used to control the sequence of instruction execution. The value in the program counter represents the address of the memory location containing the next instruction to be executed by the rules logic vRISC.

The exit register 765 and the compare register 764, are not directly accessible by the accelerator processor programs, but are accessible by the host processor. The compare register 764 contains the results of the last comparison instruction performed by the rules logic vRISC and is the only signed register in the system. The exit register 765 is set by an exit instruction executed by the rules logic vRISC and is used to pass a return value to the host processor.

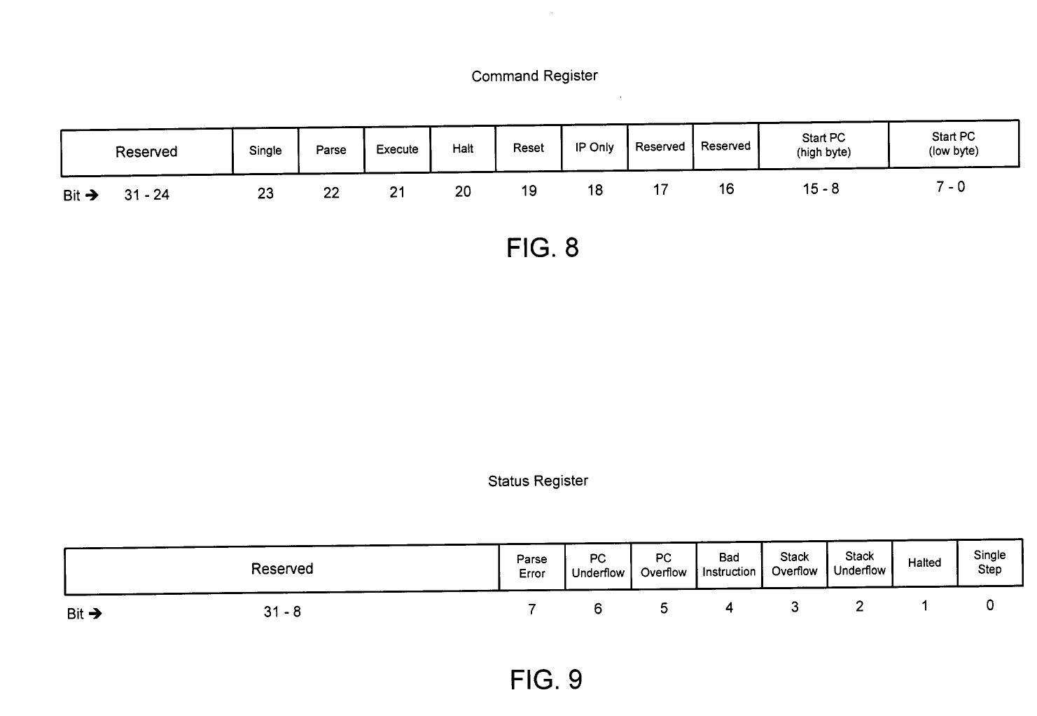

The command register is a 32-bit register writable by the host processor and used for commands directed from the host processor to the accelerator processor. The status register is a 32-bit register used to indicate to the host processor various error or status conditions than may occur during processing. The command and status registers are illustrated in FIGS. 8 and 9, respectively.

Turning now to FIG. 8, when the host processor writes to the command register, execution of the command by the rules logic vRISC is triggered. Bits 16-17 and 24-31 of the command register are reserved. Bits 18-23 are command bits used to control the operations of the accelerator processor as described more fully below.

When the Single bit is set in the command register, the accelerator processor operates in single-step mode for debugging embedded processor programs. When the single bit is set in the command register, the accelerator processor will execute a single instruction and halt. Following execution of the single instruction, the accelerator processor sets the halt bit in the status register, and interrupts the host processor signaling completion of the single step operation.

The parse bit in the command register may be used by the host processor in conjunction with the execute bit. When the parse bit is set in the command register, program execution by the accelerator processor is stalled until the next data packet is parsed. The parse bit is ignored unless the execute bit is set. The execute bit instructs the accelerator processor to begin executing the program beginning at the location indicated by the StartPC bits. The halt bit commands the accelerator processor to halt execution of a currently executing program. When the reset bit is set, the accelerator processor resets the contents of the instruction memory and all the registers. Setting the IPonly bit commands the accelerator processor to treat the arriving packet as having no Ethernet header. In this situation, the first byte of the packet must be the first byte of the IP header. If the IPonly bit is not set, then the parsing logic expects the first 14 bytes of a data set to be an Ethernet header.

As illustrated in FIG. 9, the status register may be used to indicate that a parse error has occurred, to indicate program counter overflow or underflow, that a bad instruction was encountered by the embedded processor, stack overflow or underflow, the halt condition, or single step mode. If a status bit is set to 1, the error condition coded by the particular status bit has occurred.

The registers described above represent an exemplary set of registers that may be implemented to perform data packet filtering in accordance with the present invention. A different number of registers, or different registers, may be used to accomplish data packet filtering. Furthermore, the invention is not limited to the exemplary set of commands described herein to perform data packet classification. A different command set may be implemented to accomplish a wide variety of tasks associated with data packet analysis in accordance with the methods and systems of the present invention.

In an exemplary embodiment, the rules engine logic vRISC may implement a set of nine operations to analyze and classify a data set. According to this example, each operation is defined by an instruction that is one byte in length. An instruction may have an operand included within the instruction. Alternatively, the instruction may have operands that must be pulled from the stack, or operands that follow the instruction in program memory.

The instruction sequence representing a set of rules to be applied to a data packet resides in the accelerator processor memory which is freely readable and writable by the host processor. The host processor may write new programs into memory for each data set that is processed. The accelerator processor memory may contain multiple programs for analyzing data packets of different type, or analyzing a data packet or multiple data packets in different ways.

An instruction sequence executes until an exception occurs or until an exit instruction is executed. An exception may be generated upon conditions such as a stack overflow, stack underflow, or invalid instruction. When an exit or exception occurs, the host processor is signaled through an interrupt that the packet analysis is complete. The host processor may then query the exit register and other registers in the accelerator processor memory to retrieve the results of the analysis. A description of an exemplary rules logic vRISC instruction set is provided below with reference to Table 3.

TABLE 3

| Instruction | Options/Operands |
|---|---|
| Noop | None |
| Push | 16-bit value which follows in stream |
| | 32-bit value which follows in stream |
| | Duplicate top of stack |
| | Push contents of a register |
| | Push work or half work from packet |
| Compare | 16-bit compare |
| | 32 bit compare |
| Jump | Result equal |
| | Result not true |
| | Result greater than |
| | Result less than |
| | Result greater than or equal |
| | Result less than or equal |
| | Jump always |
| And | 16-bit And |
| | 32-bit And |
| Exit | Return value may be located in a register, the next 32 bits in |
| | the instruction stream, or at top of the stack. |
| Store | Store 16-bit value |
| | Store 32-bit value |
| | Target register |
| | Value to be stored may be in-line data |
| | Value to be stored may be stack data. |
| Pop | none |
| Split | none |

Stack operations include Push and Pop instructions. A Push instruction pushes a new value onto the stack. The value may be a 16-bit or 32-bit value. The value may be a contained in a register, the next 16 or 32 bits of memory, a word from the data set or a value contained in the top of the stack. If the value to be pushed is located in a register, then the entire 32 bits of the register is pushed. If the value is to be pushed is contained in instruction memory, either the next 16 bits or the next 32 bits is pushed as a 32-bit value. If the value is a word from the data set, then the value at the top of the stack is popped and the value popped from the stack is used as the byte offset defining the location of the word from the data set to be pushed. If the value to be pushed is the top of the stack, then the top of the stack is popped off and pushed twice. A Pop instruction removes a 32-bit value from the stack.

A Compare instruction compares two 16-bit or two 32-bit values and places the results of the comparison in the compare register. The values to be compared may come from the stack, from memory, or both. The comparison operation subtracts the second value form the first value and stores the difference in the compare register. If the values compared are equal, the compare register will contain zero after the compare instruction is executed. If the first value is greater than the second value, the compare register will be positive, and if the first value is less than the second value, the compare register will be negative after the compare instruction is executed.

A Jump instruction causes the program counter to be changed depending upon the value in the compare register derived from a prior comparison instruction. A jump may be executed in the following modes: jump always, jump less than, jump greater than, jump less than or equal to, jump greater than or equal to, jump equal, and jump not equal. The jump instruction uses the next 16 bits in the instruction memory as a signed integer indicating the jump offset.

An And instruction performs a 16-bit or 32-bit bitwise logical and of two values. The two values may either be on the stack, in the instruction sequence, or a combination of both.

The Exit instruction halts execution of the program and signals the host interface processor that the data set analysis is complete. A value returned by the exit register points to a register or other location that stores the results of the data set classification. For example, the value returned by the exit command may be a register value, a value in the data set, or the value on the top of the stack.

A Store instruction causes the program to store a value in a register. The value may be a 16-bit unsigned value or a 32-bit signed value. In either case, the entire contents of the register are overwritten by the value stored. If a 16-bit value is stored, the high-order 16-bits of the register are set to zero. The value stored may either be the top value on the stack, or the next value in instruction memory, for example.

The Split instruction causes the program counter to increment the amount represented by the first half-word following the instruction if the compare register indicates that the last compare produced a value is less than zero. The Split instruction causes the program counter to increment the amount represented by the second half-word following the instruction if the compare register indicates that the last compare produced a value that is greater than zero. The Split instruction does nothing if the last compare produced a value equal to zero.

The paragraphs above describe an exemplary set of instructions that may be used for packet analysis. Additional instructions, or different instructions, may be implemented as required or desired to accomplish a wide variety of data set analysis tasks within the scope of the invention.

A specific example of an instruction sequence used to classify a data packet is provided below. In this specific example, the rule applied is to let pass any UDP packet with a destination port value of 53. The following assembler code provides the brief program sequence that may be used by the rules engine logic to implement the rule:

| | |
|---|---|
| push TCP.dstport | ;Push the destination port |
| compare32 stack 0x35 | ;Compare against 53 |
| jne next_rule | ;If not equal, processing rule complete |
| push IP.proto | ;Push protocol register |
| compare16 stack 0x8 | ;Compare against 8—indicates UDP packet |
| jne next_rule | ;If not equal, packet is not UDP |
| exit 1 | ;If equal, then exit with an exit register value of 1 |

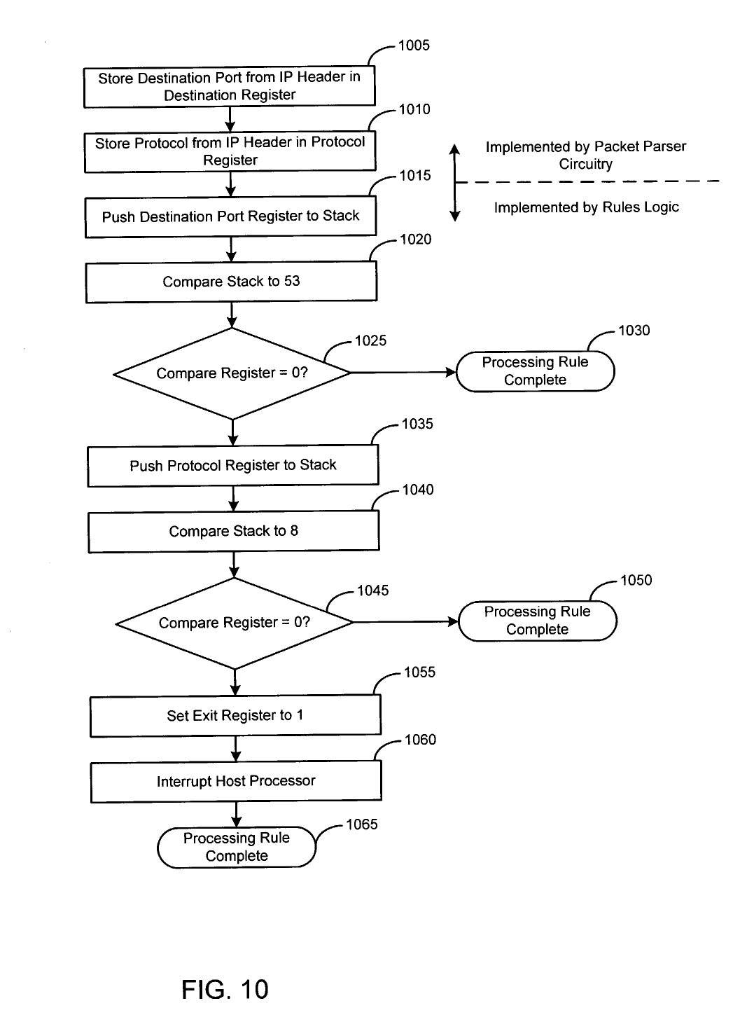

The flowchart of FIG. 10 further illustrates the machine code instruction sequence used to implement the exemplary rule. Prior to beginning the instruction sequence, the packet header is parsed by the parsing circuitry and relevant values are stored in the accelerator processor registers. In this example, the destination port from the transport, packet header, e.g., TCP or UDP header, is stored 1005 in the accelerator processor destination port register, denoted in the assembler language example as TCP.dstport. The protocol byte from the IP packet header is stored 1010 in the protocol register of the accelerator processor. The protocol register is denoted IP.proto in the assembler code above.

Classification of the data packet by the rules logic engine of the accelerator processor begins at block 1015. The value in the destination port register is pushed 1015 to the four bytes at the top of the stack. The four bytes at the top of the stack are compared 1020 to the value 53 (0x35 hexadecimal). The compare register provides the result of the comparison operation. If the value at the top of the stack is equal to 53, then the compare register contains a 0 following the compare operation. If the value at the top of the stack is less than or greater than 53, the compare register contains a negative or positive value, respectively, following the compare operation. If the compare register is not equal zero 1025, then the destination port value is not 53, and the packet will not be allowed to pass. The processing of the rule is complete 1030. If the compare register equals zero 1025, then the destination port value equals 53, and the packet will be allowed to pass if further processing by the rules engine logic determines that the packet is a UDP protocol packet.

The protocol, e.g., TCP, UDP, etc., of the packet is indicated in byte 9 of the IP packet header (see FIG. 5). A value of 8 in the protocol byte of the IP packet header indicates that the packet uses the UDP protocol. The protocol byte from the IP packet header is stored in the protocol register at block 1010 and is thus available for rules engine logic processing. The protocol register is pushed 1035 to the stack. The stack value is compared 1040 to the value 8. As previously discussed, the compare register provides the result of the comparison operation. If the value at the top of the stack is equal to 8, then the compare register contains a 0 following the compare operation. If the value at the top of the stack is not equal to 8, the compare register contains a nonzero value following the compare operation. If the compare register does not equal zero 1045, the packet is not a UDP packet and the packet will not be allowed to pass. The rules processing is complete 1050. If the compare register contains a zero, the packet meets the rules criteria: the packet is a UDP packet with destination port 53. The exit register is set 1055 to one, indicating the classification of the packet as a UDP packet with destination port 53. The accelerator processor transmits an interrupt to the host processor 1060 and classification of the data packet in accordance with the rules is complete 1065.

The above example provides a specific application of data packet analysis that may be implemented using the present invention to classify a data packet in accordance with a single rule. Those skilled in the art will recognize that numerous data packet filtering applications may be implemented using different combinations of instructions. For a more particular specification, reference may be made to the appended documents entitled PAM System Overview, PAM Specification, PAM Microdriver Specification, and Source Code pam.c, filed concurrently herewith and incorporated by reference in their entirety.

Various modifications and additions can be made to the preferred embodiments discussed hereinabove without departing from the scope of the present invention. Accordingly, the scope of the present invention should not be limited by the particular embodiments described above, but should be defined only by the claims set forth below and equivalents thereof.

What is claimed is:

1. An accelerator processor for classifying data packets according to a set of rules, the accelerator processor and a host processor arranged as an integrated circuit, the accelerator processor operating in parallel with the host processor and communicating with the host processor by a parallel bus, the accelerator processor comprising:
a bus interface coupled to the parallel bus and adapted to transfer portions of the data packets from the host processor and to return results of a classification of the data packets to the host processor;
a memory coupled to the bus interface and adapted to store a program of machine code instructions converted directly from the set of rules to be applied to the data packets and to store the results of the classification of the data packets;
a packet parser circuit coupled to the bus interface and adapted to parse each data packet portion transferred from the host processor into relevant data units and to store the relevant data units in the memory; and
a packet analysis circuit coupled to the memory and arranged to classify each data packet by executing the program of machine code instructions using the relevant data units stored in the memory.

2. The accelerator processor of claim 1, wherein the host processor is implemented using a processor core.

3. The accelerator processor of claim 1, wherein the data packets classified are IP datagrams.

4. The accelerator processor of claim 1, wherein the memory includes an instruction cache accessible by the host processor and registers for storing the relevant data units.

5. The accelerator processor of claim 1, wherein the relevant data units stored in the memory include sections of a datagram header.

6. The accelerator processor of claim 1, wherein the program of machine code instructions for classifying the data packets is stored in the memory by the host processor.

7. The accelerator processor of claim 6, wherein the program of machine code instructions is updated by the host processor in accordance with changes in the set of rules.

8. The accelerator processor of claim 1, wherein the memory includes a command register for receiving commands from the host processor directed to the packet analysis circuit for controlling the classification of the data packets.

9. The accelerator processor of claim 8, wherein the commands received from the host processor include a memory location to begin execution of the machine code instructions for classifying each data packet.

10. The accelerator processor of claim 1, wherein the memory includes a compare register for reporting the outcome of a comparison instruction to the host processor.

11. The accelerator processor of claim 1, wherein the memory includes an exit register for passing the results of the classification of the data packet to the host processor.

12. The accelerator processor of claim 1, wherein the packet analysis circuit comprises a very reduced instruction set computer.

13. The accelerator processor of claim 1, wherein the packet analysis circuit receives commands from the host processor controlling the classification of each data packet.

14. The accelerator processor of claim 1, wherein the packet analysis circuit receives commands from the host processor directing the packet analysis circuit to the memory location to begin execution of the machine code instructions stored in the memory to classify the data packet.

15. The accelerator processor of claim 14, wherein the starting point of the machine code instructions executed by the packet analysis circuit is determined by the set of rules to be applied to the data packet.

16. The accelerator processor of claim 1, wherein the machine code instructions operate on one or more of the relevant data units to classify the data packet.

17. The accelerator processor of claim 1, wherein the packet analysis circuit is configured to store an indication of the classification in a return register of the memory, the return register arranged to be accessible by the host processor.

18. The accelerator processor of claim 1, wherein the packet analysis circuit is configured to store a value resulting from a comparison operation performed by the packet analysis circuit.

19. The accelerator processor of claim 1, wherein the portions of the data packets are passed to the accelerator processor by the host processor.

20. The accelerator processor of claim 1, wherein the portions of the data packets are passed to the accelerator processor by direct memory access circuitry.

22. A method for classifying data packets in accordance with a set of rules, comprising:
storing in a memory unit of an accelerator processor a program of machine code instructions converted directly from the set of rules;
transferring one or more portions of the data packets from a host processor to the accelerator processor;
parsing portions of the data packets into relevant data units and storing the relevant data units in the memory unit of the accelerator processor;
classifying each data packet by executing the program of machine code instructions in the accelerator processor using the relevant data units; and
returning results of the classification from the accelerator processor to the host processor.

23. The method of claim 22, wherein returning the results of the classification comprises storing the results in a register accessible by the host processor.

24. The method of claim 22, wherein classifying the data packet further comprises classifying an IP datagram.

25. The method of claim 22, wherein parsing the portions of the data packet into relevant data units further comprises parsing an IP datagram header into relevant data units.

26. The method of claim 22, wherein storing the program of machine code instructions further comprises updating the program of machine code instructions in accordance with changes in the set of rules.

27. The method of claim 22, wherein classifying each data packet by executing the program of machine code instructions further comprises beginning execution of the program of machine code instructions at a location indicated by the host processor.

28. The method of claim 22, wherein classifying each data packet further comprises transferring commands from the host processor to the accelerator processor, the transferred commands controlling the classification of each data packet.

29. A system for classifying data packets, comprising:
means for storing in a memory unit of an accelerator processor a program of machine code instructions converted directly from the set of rules;
means for transferring one or more portions of the data packets from a host processor to the accelerator processor;
means for parsing portions of the data packets into relevant data units and storing the relevant data units in the memory unit of the accelerator processor;
means for classifying each data packet by executing the program of machine code instructions in the accelerator processor using the relevant data units; and
means for returning results of the classification from the accelerator processor to the host processor.
